(19) United States
(12) Patent Application Publication
(10) Pub. No.: US 2006/0185954 A1
(43) Pub. Date: Aug. 24, 2006

(54) Hydrodynamic torque converter

(76) Inventor: Wolfgang Rebholz, Friedrichshafen (DE)

Correspondence Address: DAVIS & BUJOLD, P.L.L.C., 112 PLEASANT STREET, CONCORD, NH, 03301, US

(21) Appl. No.: 10/550,231

(22) PCT Filed: Mar. 20, 2004
(86) PCT No.: PCT/EP04/02938

§ 371 Date: Sep. 20, 2005

(30) Foreign Application Priority Data
Mar. 28, 2003 (DE) 103 14 330.0

(51) Int. Cl. F16H 59/16

(52) U.S. Cl. 192/3.29

(57) ABSTRACT

A hydrodynamic torque converter has a clutch either between the drive motor and the pump impeller (2) or between the drive motor and the turbine rotor (3), preferably in order to influence the shifting process in a power shift gearbox. This clutch is controlled or regulated to operate in a slipping condition as a function of a torque determined by a torque measurement device (7). The torque measurement device (7) determines the torque of the turbine rotor (3). This makes it possible to control the drive-train of a mobile vehicle in an optimum manner.

### FIELD OF THE INVENTION

The invention relates to a hydrodynamic torque converter.

### BACKGROUND OF THE INVENTION

Hydrodynamic torque converters are often used as a continuously adjustable link between a drive motor and a transmission, preferably a power shift gearbox. For this, particularly during the starting process or when carrying out gearshifts in the gearbox, the operating parameters of the hydrodynamic torque converter must be known. It is possible in particular to determine the torque of the hydrodynamic torque converter by computer, if the load condition and speed of the drive motor and the drive output speed of the hydrodynamic converter and its performance characteristic curve are known. However, precise information about the actual operating condition of the hydrodynamic converter cannot be obtained in this way because the operating condition of the hydrodynamic converter additionally depends on other operating parameters, such as the temperature and viscosity of the pressure fluid and tolerances of the pump impeller and turbine rotor.

DE 198 57 232 C1 discloses a driver disk of a hydrodynamic torque converter, which is arranged between the drive motor and the pump impeller of the hydrodynamic torque converter and contains torque sensors in order to determine the torque of the pump impeller exactly.

The purpose of the present invention is to provide a hydrodynamic torque converter in which the torque produced by the turbine rotor is known in every operating condition.

### SUMMARY OF THE INVENTION

According to the invention, in a first embodiment the hydrodynamic torque converter comprises a torque measurement device connected to the pump impeller of the torque converter. Between the pump impeller and the drive motor is a shiftable clutch that can also be operated in a slipping condition, for example, in order to influence shifts in the downstream power shift gearbox or to be able to operate the gearbox independently of the speed of the drive motor. Since in the slipping condition of this clutch the speed of the pump impeller differs from that of the drive motor, it is not possible to determine the torque of the turbine rotor by computer from converter information.

According to the invention, in or on a shaft connected to the turbine rotor there is a torque measurement device by means of which the torque of the turbine rotor can be measured exactly. This torque can be used for the control of the clutch between the pump impeller and the drive motor or for controlling the shift elements in the downstream power shift gearbox. Preferably, the torque measurement device is made as a magnetic torque measurement device as described in U.S. Patent Application No. 2004/0112145 A1, the disclosure of which is incorporated herein by reference. In particular, an electronic control unit determines the exact torque of the turbine rotor from the values emitted by the torque measurement device. The torques determined by the electronic control unit can also be stored in a memory module and load collectives can be formed therefrom, for example, in order to determine component conditions of the power shift gearbox or of the drive train.

In another embodiment, the clutch between the pump impeller and the drive motor can be controlled in such manner that a predetermined nominal torque corresponds to the actual turbine rotor torque measured. For this, the nominal torque is continuously compared with the actual torque and the clutch is controlled and a function of the difference.

In a second embodiment, the clutch is between the turbine rotor and the drive motor and can be controlled in an analogous manner. For this, a torque sensor is again arranged on or in the turbine rotor or on a shaft connected thereto, which determines the torque of the turbine rotor. A suitable measuring device is disclosed in U.S. Patent Application Publication No. 2004/0112145 A1.

Thus, the exact torque of the turbine rotor can be used to influence actuation devices for clutches, even when the torque of the turbine rotor is influenced by a clutch between the turbine rotor and the drive motor or a clutch between the pump impeller and the drive motor.

### BRIEF DESCRIPTION OF THE DRAWINGS

The invention will now be described, by way of example, with reference to the accompanying drawings in which:

FIG. 1 is a hydrodynamic torque converter with a clutch between the turbine rotor and the drive motor; and

FIG. 2 is a hydrodynamic torque converter with a clutch between the pump impeller and the drive motor.

### DETAILED DESCRIPTION OF THE INVENTION

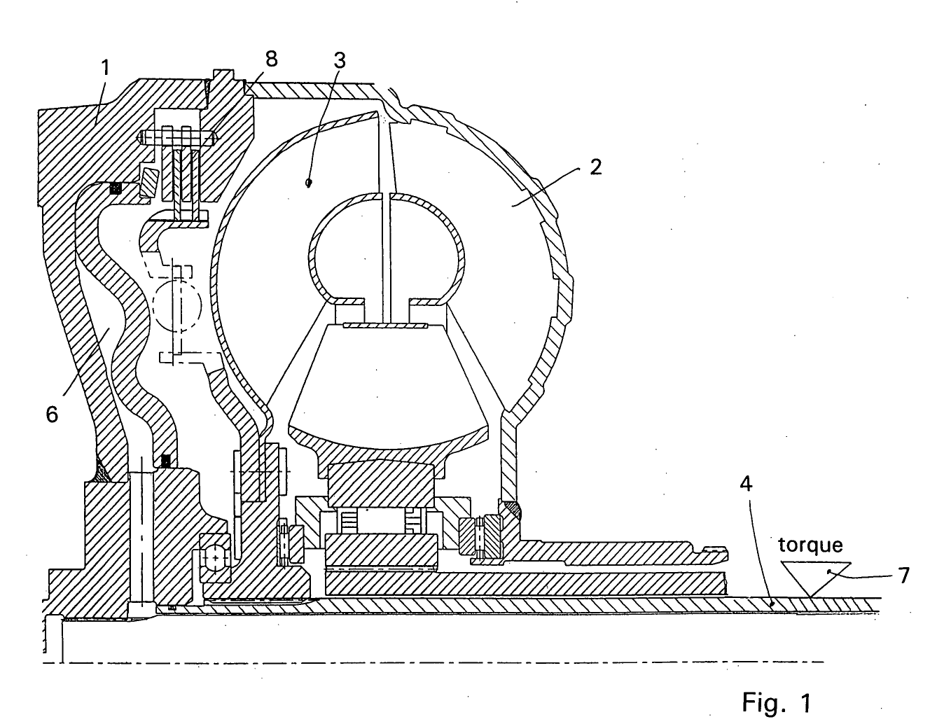

FIG. 1:

A drive motor (not shown) is connected to a converter flange 1, which is itself in rotationally fixed connection with a pump impeller 2 of the hydrodynamic torque converter. When the hydrodynamic torque converter is filled with fluid and the pump impeller 2 rotates, a torque acts on the turbine rotor 3. A drive output shaft 4 is in rotationally fixed connection with the turbine rotor 3, this shaft being used as the drive input shaft of a downstream shifting transmission, preferably a power shift gearbox for working machinery such as graders or wheel loaders. A clutch 5 can be actuated in the closing direction by pressurizing a piston space 6, and then connects the drive motor (not shown) via the converter flange 1 to the turbine rotor 3. If the clutch 5 is operated in such manner as to be in slipping operation, it is not possible from knowledge of the operating condition of the drive motor alone to determine the output torque of the drive output shaft 4. For that purpose a torque measurement device, preferably a magnetic torque measurement device as described in WO 01/96826 A2, is arranged on the drive output shaft 4. the torque measurement device 7 can also be arranged on or in the turbine rotor 3. Preferably, the signal from the said torque measurement device 7 is sent to an electronic control unit (not shown), which controls the clutch 5 as a function of this torque in such manner that, independently of the speed of the drive motor, there is a required torque at the drive output shaft 4 that assumes defined values in particular during a shift in the downstream power shift gearbox.

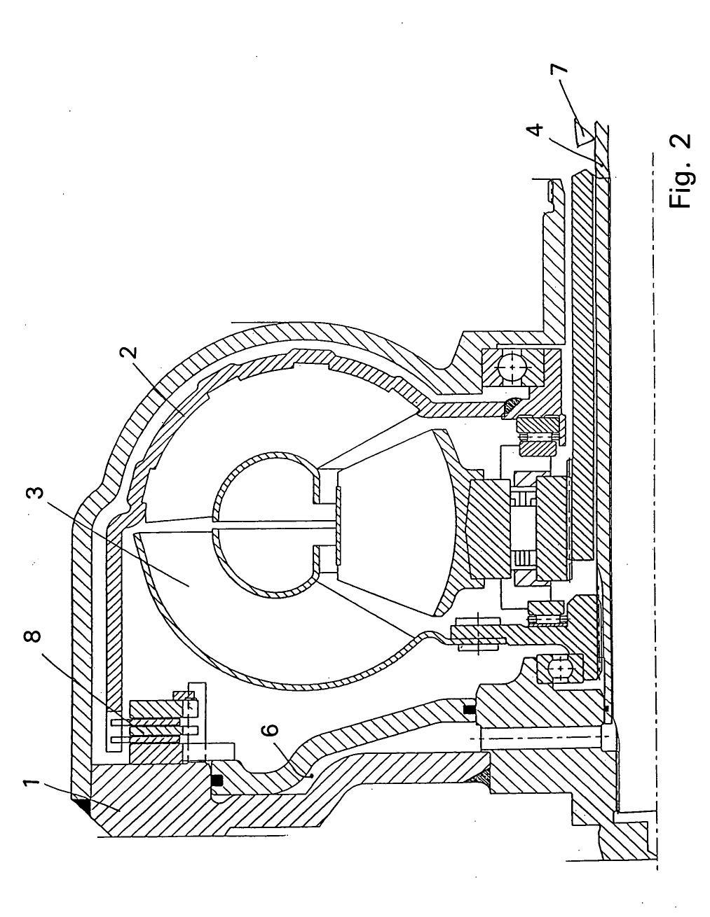

FIG. 2:

A drive motor (not shown) is in rotationally fixed connection with the converter flange 1 of a hydrodynamic torque converter. By pressurization of a piston space 6, the clutch 8 is operated in the closing direction and connects the converter flange 1 and so too the drive motor with the pump impeller 2. Rotation of the impeller 2 and filling of the hydrodynamic torque converter with fluid produces a torque on the turbine rotor 3. When the clutch 8 is slipping, the torque on the turbine rotor cannot be determined exclusively from the parameters of the drive motor or the converter flange 1, because the rotation speed of the pump impeller 2 is not known. The drive output shaft 4, which is in rotationally fixed connection with the turbine rotor 3, comprises a torque measurement device 7 which determines the torque of the turbine rotor 3. The torque measurement device 7 can also be arranged on or in the turbine rotor 3. Preferably, a magnetic torque measurement device 7 as described in WO 01/96826 A2 is used. It is also possible, however, to use torque measurement devices such as strain gauges or similar. Preferably, the torque measurement device 7 sends signals to an electronic control unit (not shown) which, as a function of the measured torque of the drive output shaft 4 and a specified torque, actuates the clutch 8 in such manner that the measured torque corresponds to the specified torque. In particular, this makes it possible thereby to influence the shifting process and thus to improve the driving comfort of the vehicle.

### REFERENCE NUMERALS

1 converter flange
2 pump impeller
3 turbine rotor
4 drive output shaft
5 clutch
6 piston space
7 torque measurement device
8 clutch

1-11. (canceled)

12. A hydrodynamic torque converter with a pump impeller (2) that can be driven by a drive motor, by means of which a turbine rotor (3) can be driven, the turbine rotor (3) being connected with a drive input shaft of a transmission (4), and with a torque measurement device (7), a clutch (8) is arranged between the pump impeller (2) and the drive motor and connects the drive motor to the pump impeller (2), the turbine rotor (3) is connected to the torque measurement device (7).

13. The hydrodynamic torque converter according to claim 12, wherein the clutch (8) can be operated in a slipping condition.

14. The hydrodynamic torque converter according to claim 12, wherein an actuation condition of the clutch (8) is one of controlled or regulated as a function of the torque determined by the torque measurement device (7).

15. The hydrodynamic torque converter according to claim 12, wherein the torque measurement device (7) is one of fitted directly on or in the turbine rotor (3).

16. The hydrodynamic torque converter according to claim 12, wherein the torque measurement device (7) is one of fitted directly on or in a shaft (4) which is connected with the turbine rotor (3) and forms a drive input shaft for a transmission.

17. A hydrodynamic torque converter with a pump impeller (2) that can be driven by a drive motor, by way of which a turbine rotor (3) can be driven, which is connected to a drive input shaft (4) of a transmission, and with a torque measurement device (7), a clutch is arranged (5) between the turbine rotor (3) and the drive motor and connects the drive motor to the turbine rotor (3), the turbine rotor (3) is connected to the torque measurement device (7).

18. The hydrodynamic torque converter according to claim 17, wherein the clutch (5) can be operated in a slipping condition.

19. The hydrodynamic torque converter according to claim 17, wherein an actuation condition of the clutch (5) is one of controlled or regulated as a function of the torque determined by the torque measurement device (7).

20. The hydrodynamic torque converter according to claim 17, wherein the torque measurement device (7) is one of fitted directly on or in the turbine rotor.

21. The hydrodynamic torque converter according to claim 17, wherein the torque measurement device (7) is one of fitted on a drive output shaft (4) which is connected with the turbine rotor.

22. The hydrodynamic torque converter according to claim 12, wherein the torque measurement device is made as a magnetic torque measurement device.
